(19) United States
(12) Patent Application Publication
(10) Pub. No.: US 2016/0072209 A1
(43) Pub. Date: Mar. 10, 2016

(54) WATERPROOF SOCKETS AND PORTS

(71) Applicant: HZO, Inc., Draper, UT (US)

(72) Inventor: Daniel J. Triplett, Providence, UT (US)

(21) Appl. No.: 14/848,194

(22) Filed: Sep. 8, 2015

Related U.S. Application Data
(60) Provisional application No. 62/046,823, filed on Sep. 5, 2014.
(60) Provisional application No. 62/046,831, filed on Sep. 5, 2014.
(60) Provisional application No. 62/046,838, filed on Sep. 5, 2014.

(51) Int. Cl. H01R 12/70; H01R 13/52

(52) U.S. Cl. CPC H01R 12/7076; H01R 13/5202

(57) ABSTRACT

An electronic card socket in an electronic device, the electronic card socket including a structure defining a receptacle configured to receive at least a portion of an electronic card; a sealing element in the structure, said sealing element configured to seal the at least a portion of the electronic card within the receptacle from moisture; and a plurality of contacts connected to the structure and extending into the receptacle, the plurality of contacts arranged complementarily to corresponding contacts on the at least a portion of the electronic card and configured to establish electrical contact with the corresponding contacts when the at least a portion of the electronic card is introduced into the receptacle.

### CROSS-REFERENCE TO RELATED APPLICATIONS

The present application claims the benefit of priority from U.S. Provisional Patent Application No. 62/046,823, filed Sep. 5, 2014, entitled “Waterproof Communication Port”; U.S. Provisional Patent Application No. 62/046,831 filed Sep. 5, 2014, entitled “Waterproof SIM Card Socket”; and U.S. Provisional Patent Application No. 62/046,838, filed Sep. 5, 2014, entitled “Waterproof Memory Card Socket”; the disclosures of which are herein incorporated by reference in their entirety.

### TECHNICAL FIELD

This disclosure relates generally to sockets and ports (e.g., SD card sockets, micro-SD card sockets, communication ports, or other sockets or ports in consumer electronics), or slots, of electronic devices and, more specifically, to memory card sockets, USB ports that will withstand exposure to moisture, liquids, corrosive materials, including, but not limited to, water.

### SUMMARY

Currently, the electrical contacts in memory card sockets (e.g., SD card sockets, micro-SD card sockets, or other removable card sockets or receptacles) are quick to corrode and fail when exposed to water, water vapor or high humidity (e.g., from long-term exposure to moisture, from current leakage when moisture is present, from corrosive liquids or other corrosive elements). Existing solutions are focused on prevent moisture from penetrating into the volume (i.e., the interior) of the electronic device of which the memory card socket is a part.

In the industry companies and manufacturers have attempted to prevent the entry of moisture into the device by mechanical seals and O-rings. Some solutions include removable rubber plugs that may be placed into ports or sockets to prevent the ingress of moisture. As used herein, the term “moisture” includes, but is not limited to, water, water vapor and/or humidity, as well as other aqueous and non-aqueous liquids.

The following disclosure may allow the practice of using replicate memory cards to protect the electrical contacts during coating of electronics in a chemical vapor deposition (CVD) or atomic layer deposition (ALD) or other deposition process wherein a coating is placed on a printed circuit board (PCB) or other electronic to render it substantially moisture-resistant. In addition, the embodiments herein may eliminate the exposure of electrical contacts or connections to environmental exposure when the cards are locked into place. The concepts may also prevent electrical contact erosion due to current leakage and the function will be transparent to the user. It will be appreciated that the embodiments disclosed herein may be applied and adapted to fit all memory cards or all sizes including NANO cards.

Multiple embodiments or techniques may be used to prevent moisture from penetrating the interior of the electronic device. In the case of a socket, the socket may include a base and a cover wherein the base may be configured to receive a memory card, SIM card or other removable electronic card or the like. The cover of the socket may be hingedly associated with the base. A sealing element, such as an O-ring, may be configured to create a seal with the base of the socket as the cover is positioned and held in place (e.g., by way of a latch, a snap or other reversibly engaging means) against the base. Thus, when the cover is closed, the cover, the sealing element and the base may seal the receptacle and its contents (e.g., a memory card, the contacts of a memory card, SIM card, SIM card contacts, or other electrical card or medium for transferring power, data or information) from external moisture. In some embodiments, such as that depicted by the images that follow, the O-ring may be carried by the cover. In other embodiments, the O-ring may be carried by the base (e.g., by the lower surface of the receptacle, or other engaging means with the receptacle or socket).

With regard to a port according to this disclosure, which may comprise any suitable type of communication port (e.g., a micro-USB port, a port with a proprietary configuration (e.g., a LIGHTNING port of an electronic device available from Apple, Inc.), or other port(s) known in the art), is configured to withstand exposure to moisture.

The disclosed communication port includes a design that prevents electrodes, or contacts within the communication port from being exposed to moisture. The design may be integral to the port, and may be configured to prevent exposure of the contacts to moisture without any action or input from the user (i.e., the user does not need to remember to reinsert a rubber plug or take any action). Further, the disclosed communication port may lack any feature that prevents moisture from entering into the port; it may merely be configured to prevent moisture from contacting the electrodes, or contacts, within the port.

In a specific embodiment, a communications port provides a seal against intrusion of moisture or other contaminants into the electrical device. The communication port includes a cover member that protects an electrical contact when no connector is present within a socket of a communication port. In some embodiments, the cover member comprises a soft, pliable material, which may also be compressible and resilient. In some embodiments, the cover member is fabricated from a rigid material and includes a resilient seal that engages the electrical contact against intrusion of a contaminant. When a connector is introduced into the socket, the connector may displace the cover member and, in some embodiments, compress and/or displace the cover member. Displacement of the cover member may reveal the contacts, and may compress the cover member and/or one or more springs located behind the cover member. In embodiments where the cover member comprises a resilient material, the cover member may resiliently return to is protective position over the contacts when the connector is removed from the socket. Removal of the connector from the socket may also remove a compressive force on any springs behind the cover member, which may enable the springs to move, or bias, the cover member back to its original position (i.e., over the contact(s)).

Other aspects, as well as features and advantages of various aspects, of the disclosed subject matter will be apparent to those of ordinary skill in the art through consideration of this disclosure and the appended claims.

### BRIEF DESCRIPTION OF THE DRAWINGS

In the drawings:

FIG. 1 provides a perspective view of a first socket in an open configurations;

FIG. 2 is a perspective view of the first socket of FIG. 1 with a memory card engaged in a base of the first socket;

FIG. 3 illustrates a perspective view the first socket of FIG. 1 in a closed configuration;

FIG. 4 illustrates a perspective view the first socket of FIG. 3 in a closed configuration with latch;

FIG. 5 depicts a perspective view of a separate embodiment of a second socket;

FIG. 6 depicts a perspective view of the second socket of FIG. 5 with a memory card engaged in a base of the second socket;

FIG. 7 depicts a top view of the second socket of FIG. 5 with a memory card engaged in the base of the second socket;

FIG. 8 depicts a longitudinal, side cross-sectional, perspective view of the second socket of FIG. 5;

FIG. 9 depicts a longitudinal, side cross-section perspective view of the second socket of FIG. 5 with a memory card engaged in the base;

FIG. 10 depicts an exploded, perspective view of components of the second socket of FIG. 5;

FIG. 11 illustrates a perspective view of a third socket in an open configuration with a SIM card engaged in a cover of the third socket;

FIG. 12 illustrates a perspective view of the third socket of FIG. 11 in a closed configuration;

FIG. 13 illustrates a longitudinal, side cross-sectional, perspective view of the third socket of FIG. 11 in the open configuration;

FIG. 14 illustrates a longitudinal, side cross-sectional, perspective view of the third socket of FIG. 11 in the closed configuration;

FIG. 15 illustrates an exploded, perspective view of the third socket of FIG. 11;

FIG. 16 depicts a perspective view of a first port in a first configuration;

FIG. 17 depicts a perspective view of the first port of FIG. 16 in a second configuration;

FIGS. 18 A-D depict the first port of FIG. 16 in a front, top, back and side view respectively;

FIGS. 19 A-B depict a longitudinal, side cross-sectional, perspective view of the first port of FIG. 16 in a first configuration and second configuration respectively; and

FIGS. 20 A-B depict a longitudinal, top cross-sectional, perspective view of the first port of FIG. 16 in a first configuration and second configuration respectively.

### DETAILED DESCRIPTION

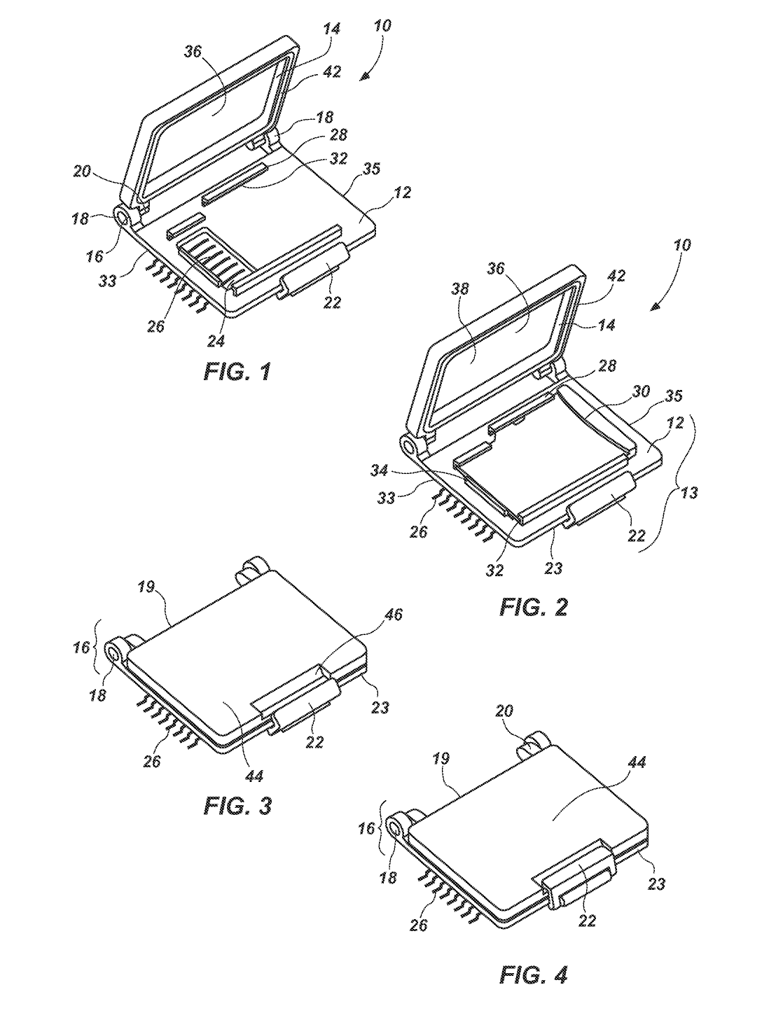

With reference to FIGS. 1-4, a socket 10 is depicted which may be a memory card socket. The socket 10 may include a base 12 and a cover 14. The base 12 and cover 14 may be connected via a hinge 16 on one side of the socket 10. The base 12 may include two or more apertures 18 on the hinge 16 side that engage two or more bosses 20 protruding from the cover 14 on the hinge 18 side 19. The bosses 20 may extend in opposite directions so as to engage the apertures 18 of base 12. The opposing side of the base may include a latch 22, on a latch side 23, which may also be hingedly connected to the base 12 and configured to engage the cover 14 when the socket 10 is in a closed configuration. The base may also include a receptacle 13 configured to receive a card 30, which may be a memory card.

The base may further include a window 24 and connectors 26, or contacts. Wherein the window 24 may allow for the connectors 26 to engage the card 30. The base may further include rails 28 or guides which extend superiorly from the base 12. The rails 28 may include a lip 32 extending at least partially medially (or toward the middle) and parallel with a top surface of the base 12. The lip 32 may be configured to hold a card 30 in place by sliding the card 30 along the rails 28 underneath the lip 32. The card 30 may only slide to a pre-determined location on the base 12 because of a stop 34 on a first end 33 of the base 10. A second end 35 of the base 12 may be the end wherein the card 30 is inserted along the rails 28. Each of the rails 28, lip(s) 32, the window 24, and stop 34 may define the receptacle 13.

The cover 14 may include a void 36 on a bottom side 38 of the cover 14. The void 36 is positioned such that it “covers” at least a portion of the top side of the base 12, the void allowing space for the card 30 to sit on the base 12 with the cover 14 covering the card 30 in its entirety. The bottom side 38 of the cover also includes a circumferential cut out that may pressedly fit an O-ring 42, or rubber ring, or the O-ring 42 may be integral to the cover 14. The O-ring 42 may engage the base 12 when the socket 10 is in a closed configuration creating a moisture-tight seal around the entire card 30. In some embodiments, the O-ring is designed to surround the card 30 without touching the card, e.g., by encompassing a greater area than the card 30. A top surface 44 of the cover 14 may include a latch engaging portion 46 opposite the hinge side 19 of the cover 14. The latch engaging portion 46 may be a step down from the top surface 44 of the cover 14 and is configured to receive a portion of the latch 22 when the socket 10 is in a closed configuration.

The connectors 26 are able to contact the card 30 through the window 24. Thus allowing a connection to be made to an electronic device that engages the socket 10.

An exterior of the base 12 of the socket 10 may be sealed. The base 12 may include an exterior seal. Alternatively, the base 12 may be sealed against a printed circuit board (PCB) of an electronic device of which the socket 10 is a part. Sealing of the base 12 against the PCB may prevent the base 12, contacts 26 of the socket 10 and contents of the receptacle of the base 12 from being exposed to moisture.

It will be appreciated that the card 30 may also engage the base through a press-fit, snap-fit, spring-fit or other means known in the art for engaging and maintaining a device in a specific configuration. It will further be appreciated that the aforementioned embodiment is modular and each of the pieces may be interchanged with other pieces to create a moisture-tight seal for the card 30.

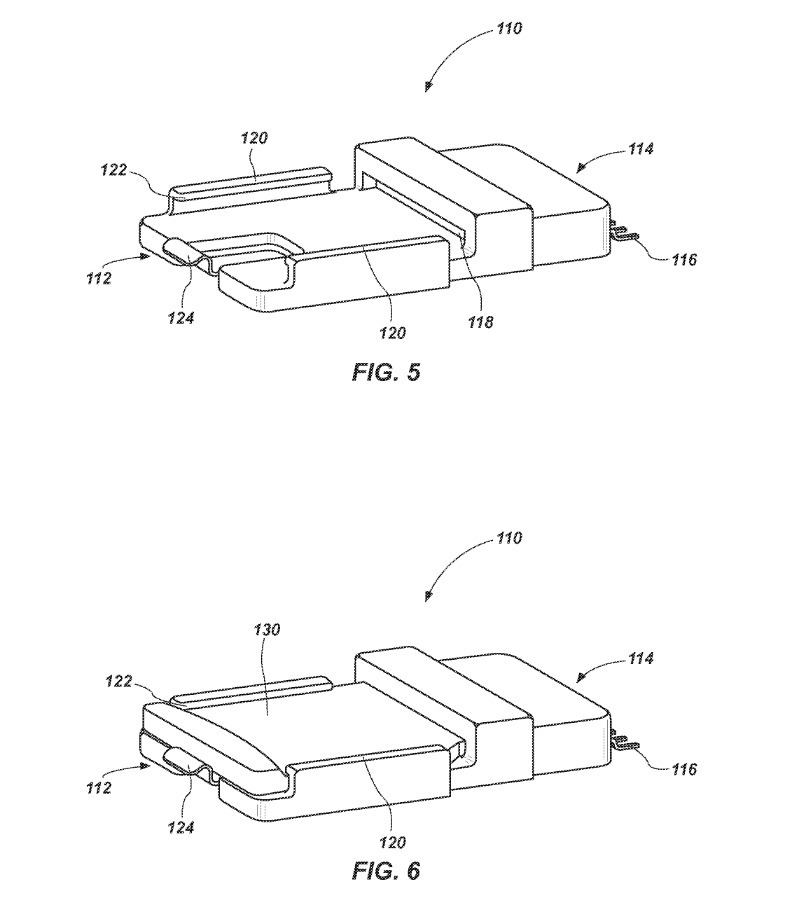

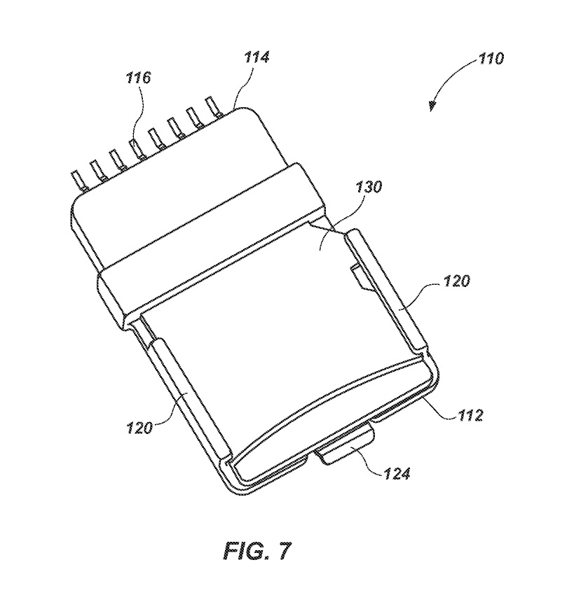

A separate embodiment of a socket is illustrated in FIGS. 5-15. With respect to FIG. 5-7 a socket 110 is configured to receive a card 130, which may be a memory or SD card. The socket 110 includes a proximal section 112 and a distal section 114 wherein the distal section may include electrical contacts 116, or connectors, which may engage an electronic device. The distal section 114 of the socket 110 may include a receptacle 118 to receive at least a portion of a card 130, and the at least a portion of the card 130 includes electrical connections.

The socket 110 may include rails 120 or guides toward the proximal section 112 that extend superiorly from a top surface of the socket 110 and each rail 120 may include a lip 122 that extends medially (or toward the middle) toward the center line of the socket 110 and parallel to the top surface of the socket 110. The rails 120 may extend from a proximal end longitudinally along the body of the socket toward the distal section 114. The rails 120 may terminate prior to reaching a distal end or may extend the entire length of the socket 110. The lip 122 and rails 120 may hold the card 130 secure to the body of the socket 110 disallowing movement of the card 130 in a lateral direction. Furthermore a clip 124, or latch, or a spring clip, may extend from the proximal end of the socket 110. The clip 124 may secure the card 130 in a longitudinal direction providing that a card 130 may not be removed from the socket 110 unless the clip 124 is pressed by a user in an inferior direction with relation to the card 130, allowing the card 130 to be removed from the socket 110 longitudinally with respect to the socket 110.

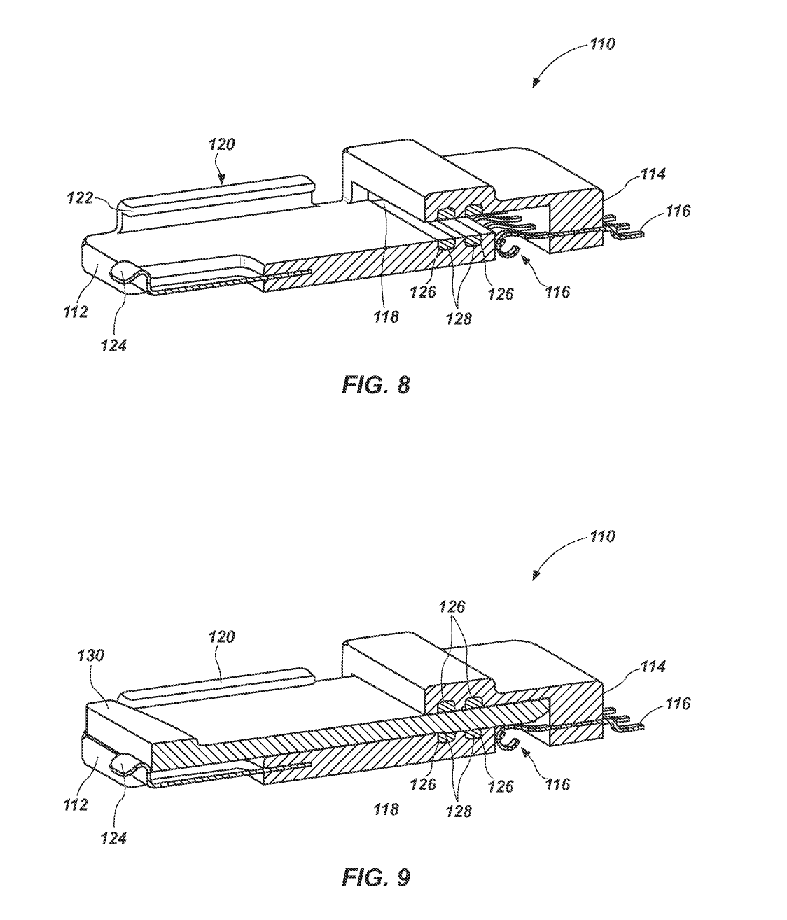

FIGS. 8 and 9 illustrate a cross-sectional side view of the socket 110. The receptacle 118 may include one or more recesses 126, or cutouts, that run circumferentially within the receptacle 118. In the present embodiment two recesses 126 are displayed with an O-ring 128 in each recess 126. In some embodiments, socket 110 may comprise one, two, three or more O-rings 128. The O-rings seal against an exterior of the card 130 when the card 130 is inserted into the receptacle 118 so moisture is unable to penetrate the seal. The seal may only seal that portion of the card 130 with the electrical contacts and not the entire card 130. The card 130 may include electrical contacts that engage the electrical contacts 116 of the socket which ultimately are engaged with an electronic device.

A portion of the socket 110 body may have a taller profile in a superior/inferior direction at the location of the receptacle 118. The taller profile at the receptacle 118 may allow for the recesses 126 to extend into the body of the socket 110 and thus allowing for engagement of the O-rings 128. The O-ring 128 may be press-fit within the recess 126 or the O-ring 128 may be integral to the recess 126.

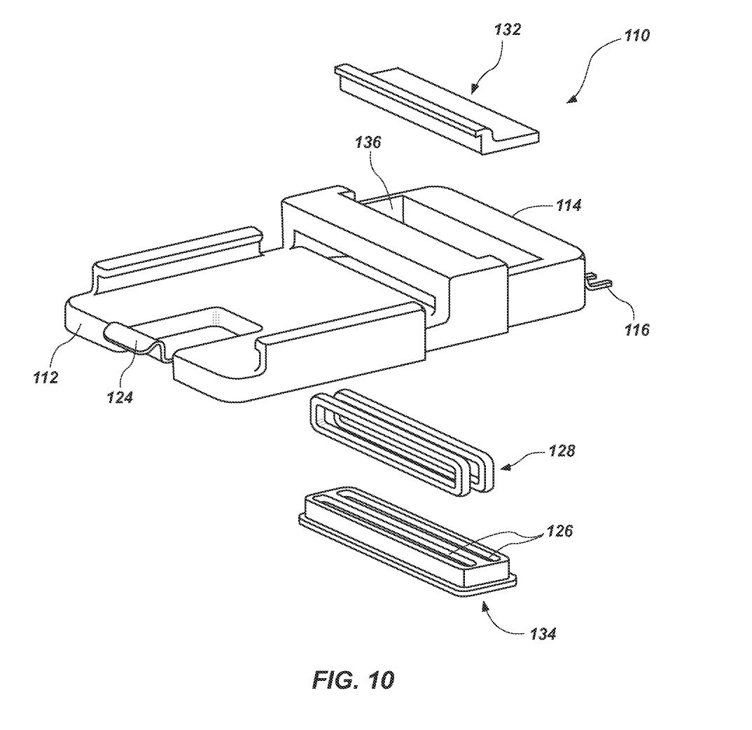

With regard to FIG. 10, the socket 110 may include other components. Previously disclosed were the electrical contacts 116 and O-rings 128. The socket 110 may further include a top insert 132 and a bottom insert 134. The socket 110 may have the electrical contacts 116 insert-molded into the socket 110 thus creating a moisture-tight seal around the electrical contacts 116. The clip 124 may also be insert molded into the socket 110. The socket 110 further includes a cavity 136 which includes the recesses 126 that may capture at least a portion, maybe half, of the O-rings 128. The top insert 132 may cover the electrical contacts superior the socket 110 body and may be glued into place. The bottom insert 134 may include the recesses 126 for capturing at least a portion, maybe the other half, of the O-rings 128. The bottom insert 134 may also be glued into place on the socket 110 body. The O-rings 128, if more than one is used, may be identical and may be custom injection molded for this application and may have a rectangular profile that is sized and shaped to create an interference fit over a portion of the card 130 that is inserted into the receptacle 118.

These two embodiments are focused on the inclusion of the O-ring style seal between the card and the socket. Actual designs of the socket and contacts and inserts are changeable and interchangeable as may be established by industry practices and standards.

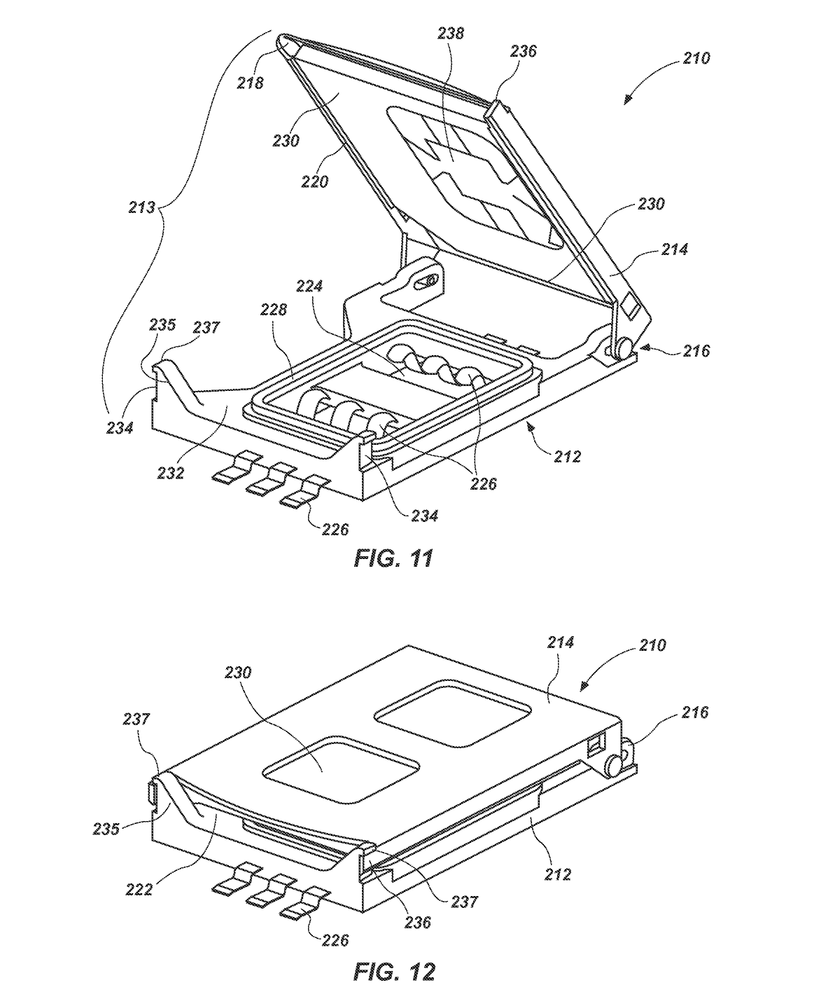

Another possible embodiment, which may be used for a SIM card, a Micro SIM card, is set forth below. With regard to FIGS. 11 and 12, a socket 210 may include a base 212 and a cover 214. The base 212 and cover 214 may be hingedly connected on a hinged end 216 of the socket 210. A card 230, which may be a SIM card, may slidably engage the cover 214. The cover 214 may include rails 218 with a lip 220 the rails extending from the body of the cover 214 and the lip extending medially toward a center line of the socket 210. The lip may hold the card 230 in place in a superior/inferior manner and the rails 218 preventing movement of the card 230 in a lateral manner. A stop 233 may be positioned toward the hinged end 216 of the cover 214 to prevent the card 230 from moving too far proximally/distally. An open end 222 opposite the hinged end 216 allows for the card 230 to slide into the rails 218. The base may also include a receptacle 213 configured to receive the card 230.

The base 212 may include a window 224 and contacts 226, or connectors, which may be exposed through the window 224. The window 224 may allow for a contact(s) from the card 230 to interface with the contacts 226 of the base 212. An O-ring 228 may be positioned along a periphery of the window 224, on the cover facing side 232 of the base 212. The O-ring 228 may provide a seal to prevent moisture ingress into the contacts 226 into the window 224 and thus the contacts 226 of the socket and the contact(s) 238 of the card 230. Each of the rails 218, lip(s) 220, the window 224, O-ring 228 and stop 233 may define the receptacle 13.

The base 212 may also include an engagement feature 235, or latch, positioned on the open end 222 of the socket 210. The engagement feature 235 may include two latches, one positioned on each lateral end of the open end 222 of the socket 210. The latches 235 may each include a recess 234 extending toward the center line of the socket 210 and a latch lip 237 extending laterally from a center line of the socket 210. The recess 234 is configured to receive a protrusion(s) 236 from the cover 214. The protrusion(s) 236 may extend from the body of the cover 214. The protrusion(s) 236 may fit into the recess(es) 234 in a snap-fit fashion. The protrusions 236 may overcome the latch lip 237 by a pressing force thus reversibly locking the cover 214 to the base 214. The latch lip 237 prevents release of the cover 214 from the base 212 unless a force is applied by a user to overcome the latch lip 236. It will be appreciated that the bottom-side of the base 212 may include a seal that seals the base against the printed circuit board (PCB) to provide a total seal of the card 230 and contacts 226.

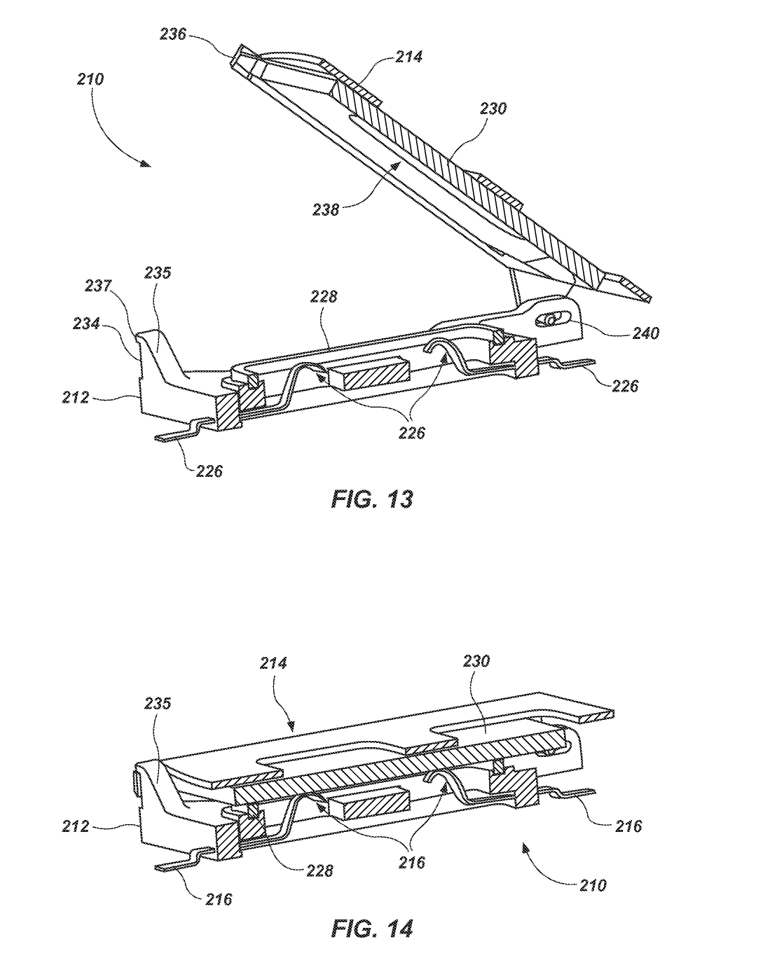

With regard to FIGS. 13 and 14, the cross-sectional view depicts the interaction of the card 230 with the cover 214. Specifically with reference to FIG. 14, the card 230, when engaged to the cover 214, and latched against the base 212, comes into contact with the contacts 226 of the base 212. More specifically the card contacts 238 touch those contacts 226 of the base 212 allow for electrical current to flow. The O-ring 228 (shown in cross-section) encircles these contacts 226, 238, preventing the ingress of moisture. The base 212 and cover 214 are latched together tightly enough to prevent exposure of the contacts 226, 238 to moisture and the base 212 and cover 214 prevent the sliding of the card 230 in any direction to maintain the moisture-resistant seal.

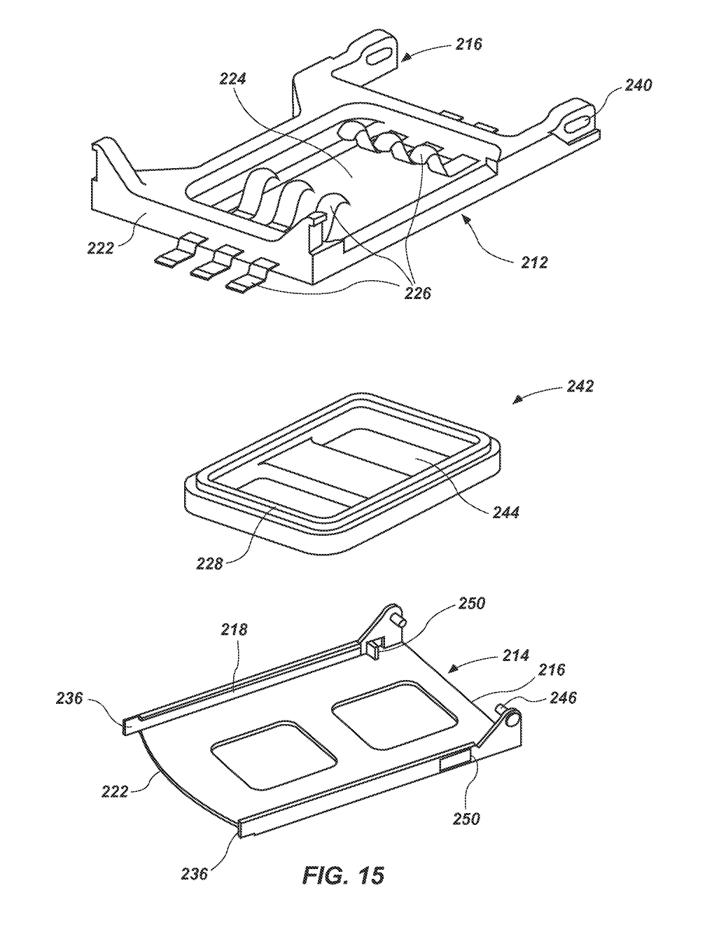

With regard to FIG. 15, the base 212 may have the contacts 226 insert molded into the base 212 thus creating watertight, or moisture-tight, seal around the contacts 226. The base 212 may include hinges 240 on the hinged end 216. The hinges 240 may be sliding hinges to facilitate the latching operation on the opposing end, or open end 222, of the base 212. As disclosed previously, the window 224 allows for the contacts of the base to be exposed to the cover 214. An O-ring carrier 242 may be molded with the base or separately, as depicted in FIG. 15. The separate carrier 242 may engage the base be either press-fit, snap fit or glued (or other engagement means) to the base 212 by being placed within a recess of the base 212 that complementary fits the carrier 242. The 0-ring 228 engages the carrier 242 and may be over molded onto/into the carrier, the bonding creating a moisture-tight barrier. The O-ring may comprise a soft durometer polymer. The carrier 242 may also include at least one window 244 similar to the base window 224 allowing the exposure of the contacts 226 through the base 212 and carrier 242.

The cover 214 (shown from the bottom side in the exploded view of FIG. 15) may be manufactured from a stamped sheet metal, such as stainless steel, or other non-corrosive metal. The cover 214 includes pins 246 to engage the slidable hinges 240 of the base 212. The side rails 218 capture the card 230 as set forth previously; however, the side rails 218 may include tabs 250, may be positioned toward the hinged end 216 (however, anywhere along the rails 218 may work). The tabs 250 may be bent to register proper insertion of the card 230. The open end 222 of the cover 214 includes the proper latch interfaces or protrusions 236.

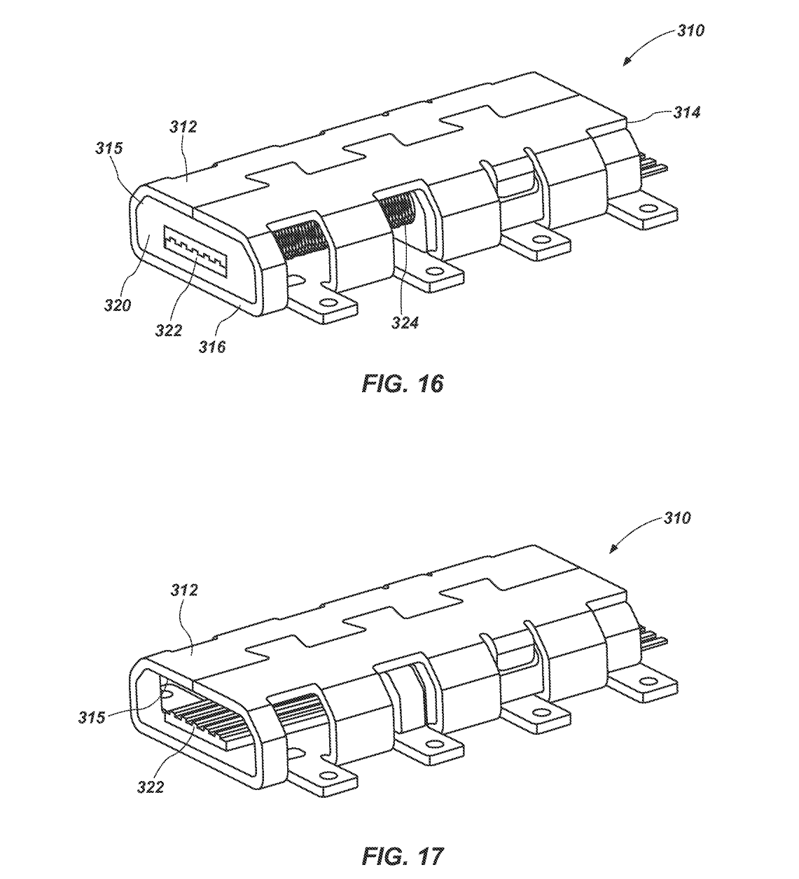

With regard to FIGS. 16 and 17, FIG. 16 illustrates a communication port 310 in a first configuration. A port body 312, or housing, may be an elongated body with contacts end 314 and an engagement end 316 with a socket 315. The contacts end may include those electrical contacts 318 that interface with an electronic device. The engagement end 316 may provide for engagement of a communication device, USB drive, flash drive, connector, or other insertable communication apparatus. In some embodiments, the electrical contacts 318 are embedded in the structure of port body 312, such that contaminants, such as moisture, are prevented from intrusion into the electrical device. The engagement end 316 may include a cover member 320 and contact board 322 which is in electrical communication with contacts 318. In some embodiments, the cover member 320 is comprised of a soft, pliable, sealable material. In some embodiments, the cover member 302 is comprised of a rigid material, e.g., polycarbonate, and includes a resilient sealing material, e.g., natural or silicone rubbers, on an inner surface of the cover member for sealing against the contact board 322. In the first position, the cover member 320 is positioned over and protects the contacts or contact board 322 within the communication port 310 from any environmental exposure, e.g., exposure to moisture or contaminants, or current leakage. In some embodiments, the cover member 320 includes an aperture with a sealable material that conforms to the outer profile of the contact board 322 and seals the contact board 322 from contaminants.

FIG. 17 shows that the cover 320 may be displaced to a second position by a communication apparatus, e.g., a USB drive, that displaces the cover 320 in the same direction as the communication apparatus interacts with the communication port 310. The cover 320 moves in a longitudinal direction within or along the port body 312. The cover member 320 is slidable over the outer profile of the contact board 322 as illustrated in FIG. 17 and exposes the electrical contacts housed on the contact board to the communication apparatus. When the cover member 320 is in the second position, the sealing of the contacts 318 in the port body 312 prevents intrusion of contaminants into the electronic device, regardless of whether the cover 320 is in the first or second position.

The communication port 310 may also include a biasing member, e.g., springs 324, which may be coiled and positioned behind the cover member 320. The springs 324, which may be coiled, behind the cover member 320 and in a somewhat relaxed state, where they push, or bias, the cover member forward, and hold the cover member 320 in place over the contact board 322 (FIG. 16). In a displaced position (FIG. 17), the springs 324 behind the cover member 320 are compressed. In some embodiments, the springs 324 may be configured to remain in their compressed states while the connector remains in place within the socket 315 of the communication port 310 and, thus, will not force the connector out of the socket 315. For example, in some embodiments, the biasing force of the spring 324 is insufficient to overcome a friction fit between the USB plug or other connector and the inner portion of the socket. When the connector is removed from the socket 315, however, the springs 324 will force the cover member 320 forward, back over the contact board 322 (i.e., to the position shown in FIG. 16). In other embodiments, insertion of a connector into the socket 315 may cause a latch to mechanically engage the cover member 320 while the connector remains within the socket 315, but may automatically disengage the cover member 320 as the connector is removed from the socket 315. When the cover member 320 is in its moisture-protective position over the contact board 322 within the socket 315 of the communication port 310, the material of the cover member 320 may seal against the contact board 322 to prevent them from being exposed to moisture.

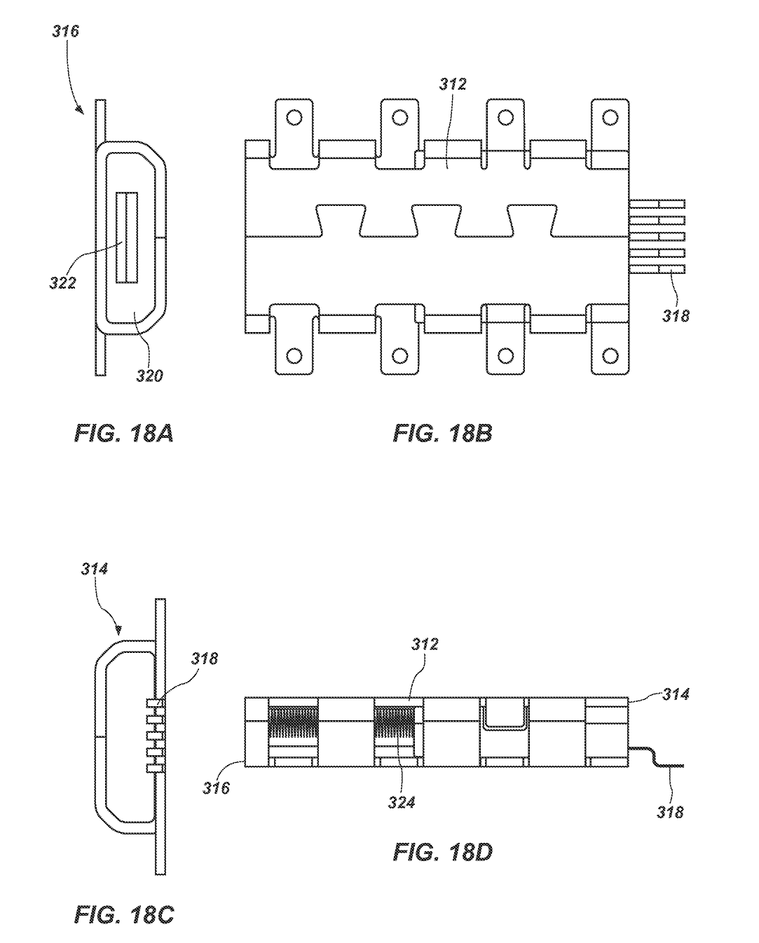

With regard to FIGS. 18 A-D, the communication port 310 may be substantially similar or substantially the same as other communication ports available in the market relative to height and width. However, the current embodiment may be longer to enable the cover member 320 and springs 324 appropriate interactions as disclosed herein, to allow for moisture protection of the contacts without a user required to insert connectors or plugs into the socket 315. It will be appreciated that the length of the communication port 310 may be variable based on the length of the socket, cover member 320 and springs 324 and it is contemplated that other varieties and methods to cover the contact board 322 for environmental and moisture protection are very much a part of this disclosure.

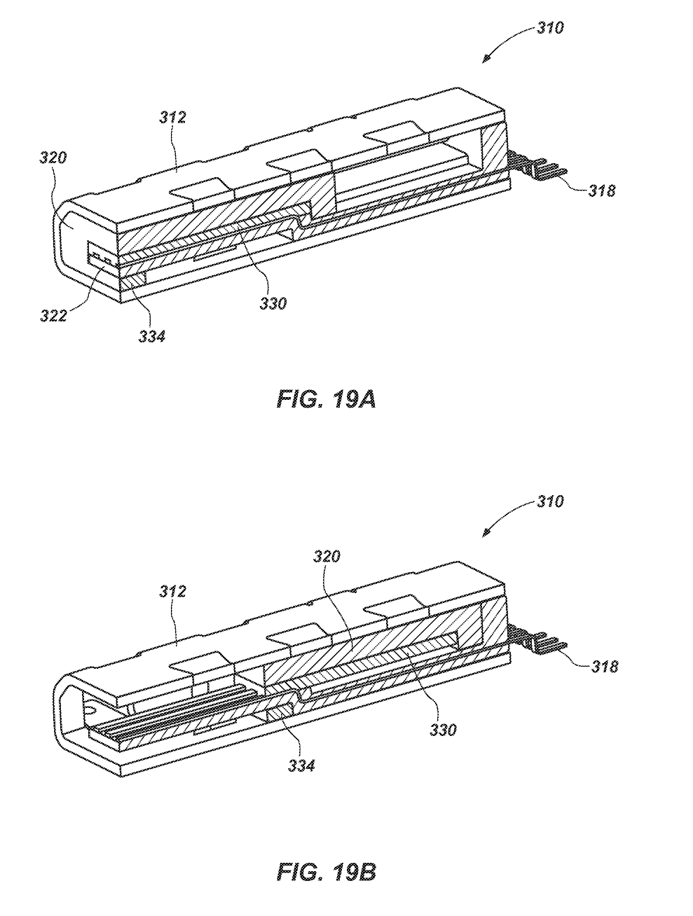

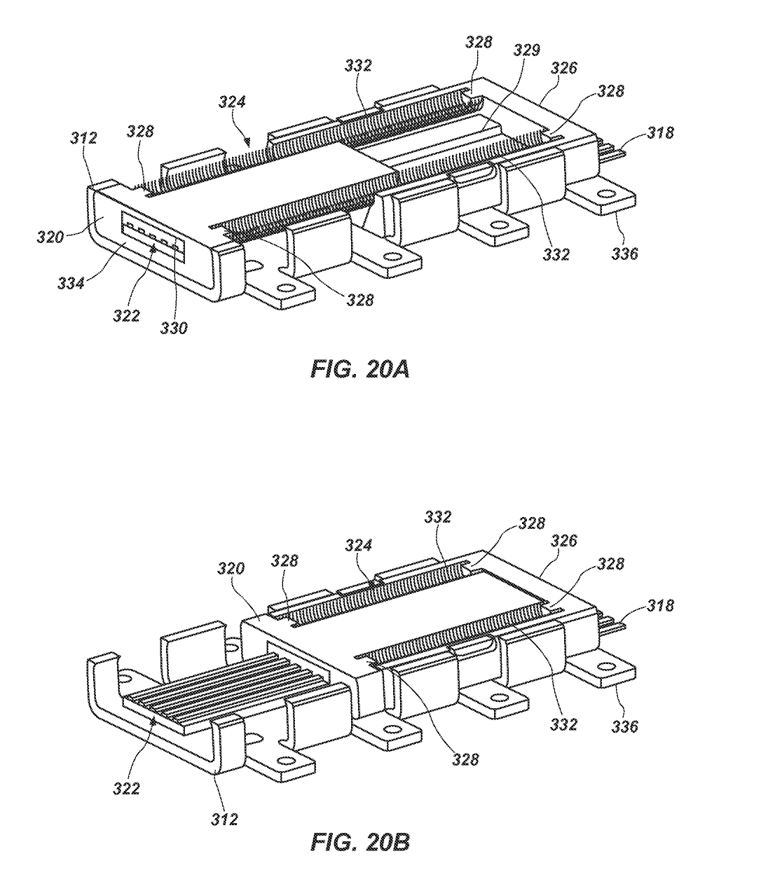

FIGS. 19 A-B depict the communication port 310 in both a first (e.g., closed) and second (e.g., open) configuration respectively. Likewise FIGS. 20 A-B illustrate the communication port 310 in both a first and second configuration respectively. The different elements of the communication port 310 are more readily observed with the cross sectional views of each of the figures.

A contact carrier 326, or retainer, includes the contacts 318 which may be insert molded into the carrier 326 body. The contact board 322 may extend toward the socket 315 from end of the carrier 326 opposite the contacts 318. The carrier 326 may include capture posts 328 configured to capture one end of the springs 324 and spring guides 332 on opposite lateral ends of the carrier 316, the spring guides 332 molded into the body of the contact carrier 326. The carrier 326 further includes a tray 329 between the spring guides 332 for receiving at least a portion of the cover member 320.

The cover member 320 may slide as previously disclosed. The cover member 320 may be injection molded and a sealing element 330, which may be adjacent to and engage with the contact board 322, may be deformable and may be over molded or bonded to the cover member 320. The cover member 320 also includes capture posts 328 configured to capture one end of the springs 324, opposite the carrier 326. Spring guides 332 may also be molded into the body of the cover member 320 to maintain the springs in a defined pathway. The cover member may also include a supporting element 334 positioned inferior the contact board 322 to prevent cantilever bending due to sealing forces.

The port body 312 may be manufactured from stamped and folded sheet metal. The port body 312 may encompass the carrier 326 with the cover member 320, the springs 324, the supporting element 334 and the sealing element 330. The port body may include securement flaps 336, or wings or mounting tabs that extend laterally away from the port body 312. The flaps 336 may include holes to allow for securement elements, such as screws or rivets, to pass through and secure the communication port 310 to an electronic device.

When the cover member 320 is displaced with a connector the cover member may slide longitudinally into or onto the tray 329 of the contact carrier 326. The sealing element 330 may also slide into or onto the tray 329 as well. The supporting element 334 of the cover member 320 may slide along an inside wall of the port body 312, again, preventing any bending of the contact board 322.

Assembly of the different elements of the communication port 310 may include placing the cover member 320 tip over a proximal end of the contact board 322; placing the springs 324 within the spring guides 332 and seating each end of the springs 324 to the spring posts 328; compressing the cover member 320 into the contact carrier 326 to fully seat all the components; inserting the assembly into the back of the port body 312 until the tip of the contact board 322 is even with the front end of the port body 320; bending locking tabs of the port body 312 into complementary pockets in the contact carrier 326. It will be appreciated that the assembly may also be inserted from the front as well depending on whether a stop or lip is manufactured on the front end of the port body 312.

The proposed embodiments may prevent moisture ingress into the contacts of the electronic device(s). Alternatively, the concepts herein may allow for coating of an electronic device with a parylene (poly(chloro-p-xylylene) or polyp-xylylene) or others) coating without the need to mask or demask the contacts with a glue, hot melt, tape or other masking elements as set forth in U.S. patent applications Ser. Nos. 13/735,862; 13/737,709; 14/794,713; and 14/157,684 which are herein incorporated by reference. Furthermore it would prevent the need to ablate or remove any coatings like those methods set forth in U.S. patent applications Ser. Nos. 14/157,743 and 14/213,765 which are herein incorporated by reference.

Other aspects, as well as features and advantages of various aspects, of the disclosed subject matter will become apparent to those of ordinary skill in the art through consideration of the preceding disclosure.

Although the preceding disclosure provides many specifics, these should not be construed as limiting the scope of any of the ensuing claims. Other embodiments may be devised which do not depart from the scopes of the claims. Features from different embodiments may be employed in combination. The scope of each claim is, therefore, indicated and limited only by its plain language and the full scope of available legal equivalents to its elements.

What is claimed:

1. An electronic card socket in an electronic device, the electronic card socket comprising:
a structure defining a receptacle configured to receive at least a portion of an electronic card;
a sealing element in the structure, said sealing element configured to seal the at least a portion of the electronic card within the receptacle from moisture; and
a plurality of contacts connected to the structure and extending into the receptacle, the plurality of contacts arranged complementarily to corresponding contacts on the at least a portion of the electronic card and configured to establish electrical contact with the corresponding contacts when the at least a portion of the electronic card is introduced into the receptacle.

2. The electronic card socket of claim 1, wherein the electronic card is a memory card.

3. The electronic card socket of claim 2, wherein the receptacle is configured to receive an entirety of the memory card and the sealing element is configured to seal the entirety of the memory card within the receptacle.

4. The electronic card socket of claim 3, wherein the receptacle is configured to receive the entirety of the memory card as the entirety of the memory card is laid within the receptacle, and further comprising:
a cover configured to be positioned over the receptacle and against the sealing element in a manner that seals the entirety of the memory card within the receptacle as the cover is positioned over the receptacle and the memory card and held against the seal.

5. The electronic card socket of claim 2, wherein the receptacle is configured to receive a portion comprising some but not all of the memory card, and the sealing element is configured to seal the portion of the memory card within the receptacle.

6. The electronic card socket of claim 5, wherein the receptacle is configured to receive a contact-bearing end of the memory card.

7. The electronic card socket of claim 6, wherein the sealing element is configured to engage and seal against the memory card upon insertion of the contact-bearing end of the memory card into the receptacle.

8. The electronic card socket of claim 7, wherein the sealing element comprises an O-ring protruding from a periphery of an opening of the receptacle.

9. A method for protecting contacts of an electronic card from moisture, comprising:
introducing at least a portion of the electronic card into a receptacle of an electronic card socket; and
sealing at least the portion of the electronic card, including a plurality of contacts of the electronic card, within the receptacle.

10. The method of claim 9, wherein sealing occurs automatically upon placement of at least the portion of the electronic card within the electronic card socket.

11. The method of claim 9, wherein sealing includes positioning a cover over the receptacle of the electronic card socket and includes sealing an entirety of the electronic card within the receptacle.

12. The method of claim 11, wherein the electronic card is a memory card.

13. A memory card socket for an electronic device, comprising:
a structure defining a receptacle configured to receive a memory card;
a sealing element associated with the structure, configured to seal at least the portion of the memory card within the receptacle from contaminants; and
a plurality of contacts connected to the structure and extending in the receptacle, the plurality of contacts arranged complementarily to corresponding contacts on the memory card and configured to establish electrical contact with the corresponding contacts when the memory card is introduced into the receptacle.

14. The memory card socket of claim 13, wherein the receptacle is configured to receive the memory card as the memory card is laid within the receptacle, and further comprising:
a cover configured to be positioned over the receptacle and a memory card within the receptacle, to force the memory card toward a surface of the receptacle to enable electrical contact between the plurality of contacts in the receptacle and the corresponding contacts of the SIM card and to seal the plurality of contacts and the corresponding contacts from exposure to contaminants when the cover is closed with respect to the receptacle.

15. The memory card socket of claim 14, wherein the sealing element is configured to create a seal between the cover and the surface of the receptacle as the cover is positioned and held in place over the memory card.

16. The memory card socket of claim 13, wherein the memory card is a SIM card.

17. A method for protecting contacts of a memory card from moisture, comprising:
introducing a memory card into a receptacle of a memory card socket; and
creating a seal between a surface of the memory card and a surface of the receptacle to prevent exposure of contacts of the memory card to moisture.

18. The method of claim 17, wherein introducing a memory card comprises introducing a SIM card.

19. A communication port for an electronic device, comprising:
a structure defining a socket and comprising a plurality of contacts within the socket; and
a cover member positioned within the socket, the cover member configured for movement between a first position, in which the cover member is seals the plurality of contacts from exposure to contaminants, and an second position, in which the cover member is displaced from the plurality of contacts.

20. The communication port of claim 19, wherein the cover member comprises a material that seals against the plurality of contacts when the cover member is in the first position.

21. The communication port of claim 20, wherein the cover member comprises a compressible, resilient material.

22. The communication port of claim 20, wherein the plurality of contacts comprises at least one contact member having an outer profile, and the cover member defines an aperture that conforms to the outer profile of the contact member.

23. The communication port of claim 22, wherein the cover comprises a compressible, resilient material providing a seal with the outer profile of the contact board.

24. The communication port of claim 19, further comprising:
at least one biasing member positioned to bias the cover member into the first position.

25. The communication port of claim 24, wherein the at least one biasing member is configured to enable the cover member to be displaced to the second position upon insertion of a connector into the socket.

26. The communication port of claim 25, wherein the at least one biasing member is provide with insufficient biasing force to displace the connector from the socket.

27. The communication portion of claim 19, wherein the plurality of contacts are embedded in the structure to prevent passage of contaminants from the socket to and interior of the electronic device.

28. A method for protecting contacts of a communication port of an electronic device from moisture, comprising:
automatically biasing a cover member over an exposed portion of a plurality of contacts within a socket of the communication port when no connector is present within the socket, the cover member sealing against the plurality of contacts to limit exposure of the plurality of contacts to contaminants.

29. The method of claim 28, further comprising:
automatically displacing the cover member upon introducing a connector into the socket, enabling the plurality of contacts to electrically communicate with corresponding contacts of the connector.
